(19) United States
(12) Patent Application Publication
(10) Pub. No.: US 2021/0044142 A1
(43) Pub. Date: Feb. 11, 2021

(54) UNINTERRUPTED POWER SUPPLY APPARATUS

(71) Applicant: FUJI ELECTRIC CO., LTD., Kanagawa (JP)

(72) Inventors: Shota OKI, Hyogo (JP); Takuya KIMIZU, Hyogo (JP)

(21) Appl. No.: 17/079,665

(22) Filed: Oct. 26, 2020

Related U.S. Application Data
(63) Continuation of application No. PCT/JP2019/030906, filed on Aug. 6, 2019.

(30) Foreign Application Priority Data
Apr. 17, 2019 (JP) 2019-078730

(51) Int. Cl. H02J 9/06

(52) U.S. Cl. CPC H02J 9/062; H02J 9/068

(57) ABSTRACT

An uninterrupted power supply apparatus includes input lines configured to receive AC power from an AC power supply having a grounded neutral point, a converter configured to convert the AC power of the input lines to DC power for output to intermediate lines, a power storage unit connected to the intermediate lines, an inverter configured to convert DC power of the intermediate lines into AC power for output to output lines, grounding capacitors connected between the input lines and a ground, a phase voltage detecting unit configured to detect phase voltages between the input lines and the ground, and a control unit configured to monitor fluctuations of the phase voltages detected by the phase voltage detecting unit to detect a failure that causes abnormal voltage to the input lines.

### CROSS-REFERENCE TO RELATED APPLICATIONS

This application is a continuation of International Application PCT/JP2019/030906, filed on Aug. 6, 2019 and designated the U.S., which is based on and claims priority to Japanese Patent Application No. 2019-078730 filed on Apr. 17, 2019, with the Japan Patent Office. The entire contents of these applications are incorporated herein by reference.

### BACKGROUND OF THE INVENTION

### 1. Field of the Invention

The disclosures herein relate to an uninterrupted power supply apparatus.

### 2. Description of the Related Art

An uninterrupted power supply apparatus as known in the art includes a rectifier for converting AC power from a non-grounded AC power supply into DC power, an inverter for converting the DC power output of the rectifier into AC power, and a battery connected to a DC intermediate circuit situated between the DC side of the rectifier and the DC side of the inverter. With respect to such an uninterrupted power supply apparatus, there is a technology known in the art that provides, on the AC side of the rectifier, a grounding capacitor connecting an AC circuit line and the ground and a current transformer for detecting a ground fault current so as to detect a ground fault with respect to the battery (see, for example, Patent Document 1).

When a ground fault occurs, ground fault current flows between the ground fault point and the ground capacitor. A ground fault detection circuit used in the related art detects an abnormal current caused by this ground fault current with a current transformer so as to detect the occurrence of a ground fault.

In the configuration in which the neutral point of the AC power supply is grounded, however, a closed loop path through which current flows via the ground is formed between the AC power supply and the ground capacitor. This causes the current flowing through the current transformer to be reduced, resulting in a situation in which the current transformer fails to detect an abnormal current. If the magnitude of current flowing through the current transformer does not reach the detection level of the current transformer, no abnormal current can be detected. Further, lowering the current transformer detection level (i.e., increasing the current transformer detection sensitivity) may cause a non-faulty current to be falsely detected as an abnormal current. In the prior art as described above, a failure such as a ground fault may not be detected in the configuration in which the neutral point of AC power supply is grounded.

Accordingly, the present disclosures provide an uninterrupted power supply apparatus capable of detecting a fault when an abnormal voltage occurs at the input line of AC power supplied from an AC power supply that has a grounded neutral point.

[Patent Document 1] Japanese Patent Application Publication No. H7-146321

### SUMMARY OF THE INVENTION

According to one embodiment, an uninterrupted power supply apparatus includes input lines configured to receive AC power from an AC power supply having a grounded neutral point, a converter configured to convert the AC power of the input lines to DC power for output to intermediate lines, a power storage unit connected to the intermediate lines, an inverter configured to convert DC power of the intermediate lines into AC power for output to output lines, grounding capacitors connected between the input lines and a ground, a phase voltage detecting unit configured to detect phase voltages between the input lines and the ground, and a control unit configured to monitor fluctuations of the phase voltages detected by the phase voltage detecting unit to detect a failure that causes abnormal voltage to the input lines.

According to at least one embodiment, an uninterrupted power supply apparatus is provided that is capable of detecting a fault when an abnormal voltage occurs at the input line of AC power supplied from an AC power supply that has a grounded neutral point.

### BRIEF DESCRIPTION OF THE DRAWINGS

Other objects and further features of the present invention will be apparent from the following detailed description when read in conjunction with the accompanying drawings, in which:

FIG. 1 is a drawing illustrating an example of the configuration of an uninterrupted power supply apparatus according to an embodiment;

FIG. 2 is a drawing illustrating an example of waveforms in the case of a DC ground fault;

FIG. 3 is a drawing illustrating an example of waveforms in the case of a filter capacitor failure;

FIG. 4 is a block diagram illustrating an example of the configuration of a failure detecting unit; and

FIG. 5 is a drawing illustrating an example of a sampling monitor period.

### DESCRIPTION OF THE PREFERRED EMBODIMENTS

In the following, embodiments of the present disclosures will be described with reference to accompanying drawings.

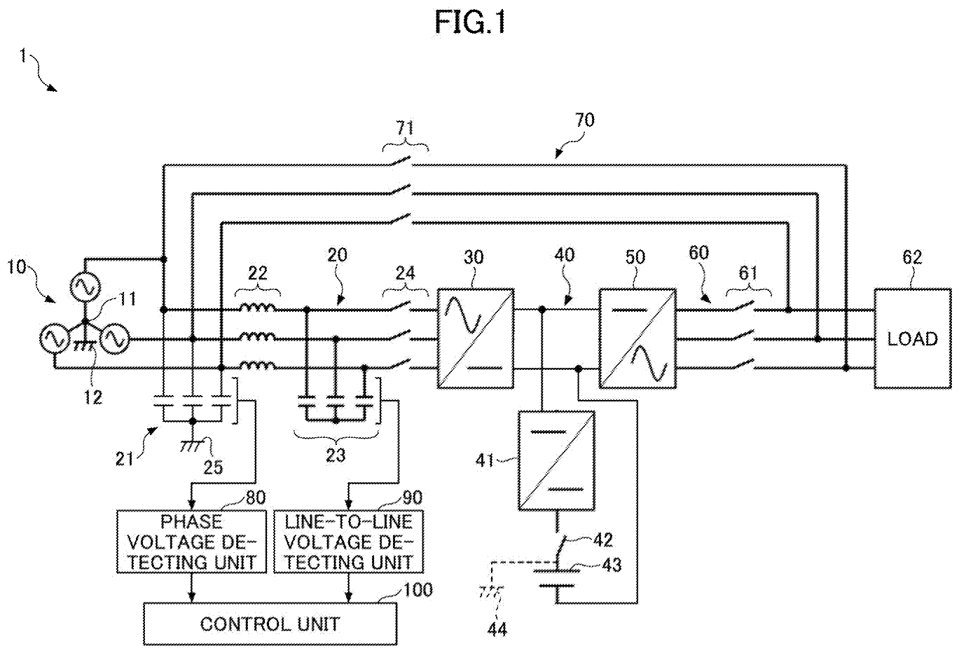

FIG. 1 is a drawing illustrating an example of the configuration of an uninterrupted power supply apparatus according to an embodiment. An uninterrupted power supply apparatus 1 illustrated in FIG. 1 is a UPS device that continuously supplies the power stored in a power storage unit 43 to a load 62 via an inverter 50 when a power failure such as a power outage or an instantaneous power cut occurs in an AC power supply 10, thereby protecting the load 62 from a power failure.

The AC power supply 10 has a neutral point 11 connected to the ground at a grounding point 12. The AC power supply 10 is a three-phase AC power supply that outputs three-phase AC power (U-phase, V-phase, W-phase), for example. The AC power supply 10 may be a commercial power supply, but is not limited to this.

The uninterrupted power supply apparatus 1 includes input lines 20, a converter 30, a power storage unit 43, an inverter 50, a phase voltage detecting unit 80, a line-to-line voltage detecting unit 90, and a control unit 100.

The input lines 20 constitute a three-phase current path through which AC power is input from the AC power supply 10 having the grounded neutral point 1. The input lines 20 are connected between the AC power supply 10 and the converter 30. The input lines 20 include grounding capacitors 21, filter reactors 22, filter capacitors 23, and input contactors 24.

The grounding capacitors 21 are connected between the respective input lines 20 and the ground. The grounding capacitors 21 are three phase capacitors each of which has one end connected to a corresponding one of the input lines 20 and the other end connected in common to the ground at a grounding point 25. The grounding capacitors 21 are situated between the AC power supply 10 and the filter capacitors 23.

The filter reactors 22 are inserted in series into the respective input lines 20. The filter reactors 22 are three phase reactor elements each of which is inserted in series into a corresponding one of the input lines 20. The filter reactors 22 are situated between the grounding capacitors 21 and the filter capacitors 23, but may alternatively be situated between the filter capacitors 23 and the converter 30.

The filter capacitors 23 are connected to the input lines 20 in a star connection. The filter capacitors 23 are three-phase capacitors each of which has one end connected to a corresponding one of the input lines 20 and the other end connected in common to the other ends of the other capacitive elements. The filter capacitors 23 are situated between the grounding capacitors 21 and the converter 30.

The input contactors 24 are inserted in series into the respective input lines 20. The input contactors 24 are three-phase input contactors each of which is inserted in series into a corresponding one of the input lines 20. The input contactors 24 are situated between the filter capacitors 23 and the converter 30.

The converter 30 is an AC-DC converter that converts the AC power of the input lines 20 into DC power for output to the intermediate lines 40 in accordance with a pulse-width-modulated converter control signal supplied from the control unit 100. The configuration of the converter 30 may be such that a plurality of switching devices, to which respective diodes are connected in reverse parallel, are connected in a three-phase bridge configuration, for example. Examples of the switching devices include IGBTs (insulated gate bipolar transistors), MOSFETs (metal oxide semiconductor field effect transistors), and the like.

The intermediate lines 40 is a pair of wires through which DC power is supplied from the converter 30, and may sometimes be referred to as a DC link. The intermediate lines 40 include a positive wire and a negative wire.

The power storage unit 43 is connected to the intermediate lines 40, and stores the DC power output from the converter 30 after the conversion. The power storage unit 43, which stores the DC power supplied from the intermediate lines 40, discharges the stored DC power to the intermediate lines 40. The power storage unit 43 has a positive electrode connected to the positive wire of the intermediate lines 40 and a negative electrode connected to the negative wire of the intermediate lines 40. In other words, the negative electrode of the power storage unit 43 is not wired to the ground. The power storage unit 43 may be connected to the intermediate lines 40 via an intermediate contactor 42 for stopping the current flowing between the power storage unit 43 and the intermediate lines 40. The power storage unit 43 may be connected to the intermediate lines 40 via a charge/discharge converter 41.

The charge/discharge converter 41 is a DC-DC converter that performs charge/discharge control between the intermediate lines 40 and the power storage unit 43 in accordance with a pulse-width-modulated charge/discharge control signal supplied from the control unit 100.

The inverter 50 is a DC-AC converter that converts the DC power of the intermediate lines 40 into AC power for output to output lines 60 in accordance with a pulse-width-modulated inverter control signal supplied from the control unit 100. The configuration of the inverter 50 may be such that a plurality of switching devices, to which respective diodes are connected in reverse parallel, are connected in a three-phase bridge configuration, for example. Examples of the switching devices include IGBTs, MOSFETs, and the like.

The output lines 60 are a three-phase current path through which AC power is supplied from the inverter 50. The output lines 60 are connected between the inverter 50 and the load 62. The output lines 60 has output contactors 61. The AC power output from the uninterrupted power supply apparatus 1 is supplied to the load 62 via the output lines 60.

The output contactors 61 are inserted in series into the respective output lines 60. The output contactors 61 are three-phase output contactors each of which is inserted in series into a corresponding one of the output lines 60. The output contactors 61 are situated between the AC output of the inverter 50 and the connection point between a bypass circuit 70 and the output lines 60.

The bypass circuit 70 is a three-phase current path that bypasses the filter capacitors 23, the converter 30, the intermediate lines 40, and the inverter 50. The bypass circuit 70 has one end connected to the input lines 20 between the AC power supply 10 and the filter capacitors 23, and has the other end connected to the output lines 60 between the inverter 50 and the load 62. The bypass circuit includes bypass contactors 71 for opening and closing the path through the bypass circuit 70. The bypass contactors 71 are three-phase bypass contactors each of which is inserted in series into a corresponding one of the lines of the bypass circuit 70.

The phase voltage detecting unit 80 is a sensor unit which detects the phase voltages Vu, Vv, and Vw between the input lines 20 and the ground and outputs a three phase voltage detecting signal corresponding to the detected phase voltages Vu, Vv, and Vw. The phase voltage Vu is the potential difference between the U phase line of the input lines 20 and the grounding point 25. The phase voltage Vv is the potential difference between the V phase line of the input lines 20 and the grounding point 25. The phase voltage Vw is the potential difference between the W phase line of the input lines 20 and the grounding point 25.

The line-to-line voltage detecting unit 90 is a sensor unit that detects line-to-line voltages Vuv, Vvw, and Vwu of the input lines 20, and outputs three line-to-line voltage detection signals corresponding to the detected voltage values of the line-to-line voltages Vuv, Vvw, and Vwu. The line-to-line voltage Vuv is a difference in potential between the U phase line and the V phase line of the input lines 20. The line-to-line voltage Vvw is a difference in potential between the V phase line and the W phase line of the input lines 20. The line-to-line voltage Vwu is a difference in potential difference between the W phase line and the U phase line of the input lines 20.

The control unit 100 controls power conversion operations of the converter 30, the inverter 50, and the charge/discharge converter 41 based on the detected voltage and current values at various points in the uninterrupted power supply apparatus 1. The control unit 100 uses pulse width modulation to control the noted power conversion operations to achieve a desired state based on the detected AC voltage values and AC current values on the input lines 20, the detected DC voltage values on the intermediate lines 40, and the detected AC voltage values and AC current values on the output lines 60, for example. It may be noted that the AC voltage values on the input lines 20 are detected by the phase voltage detecting unit 80.

The control unit 100 compares a carrier wave having a predetermined carrier frequency Fc (e.g., 5 kHz) with a voltage command for adjusting the DC voltage on the intermediate lines 40 to a target voltage Vc, thereby generating a pulse-width-modulated converter control signal. The control unit 100 causes the plurality of switching devices of the converter 30 to perform switching operations in response to the converter control signal, thereby adjusting the voltage of the DC power output on the intermediate lines 40 to the target voltage Vc.

The control unit 100 compares a carrier wave having a carrier frequency (e.g., 25 kHz) higher than the carrier frequency Fc for the converter 30 with a voltage command for adjusting the DC voltage applied to the power storage unit 43 to a target voltage Vs, thereby generating a pulse-width-modulated charge/discharge control signal. The control unit 100 causes the plurality of switching devices of the charge/discharge converter 41 to perform switching operations in response to the charge/discharge control signal, thereby adjusting the DC voltage applied to the power storage unit 43 to the target voltage Vs.

The control unit 100 has the function to detect a failure that causes an abnormal voltage on the input lines 20. In the following, such a failure detection function will be described.

During the time in which the uninterrupted power supply apparatus 1 is operating normally, the phase voltages Vu, Vv, and Vw and the line-to-line voltages Vuv, Vvw, and Vwu do not have fluctuations responsive to the frequency components inclusive of the carrier frequency Fc of the converter 30.

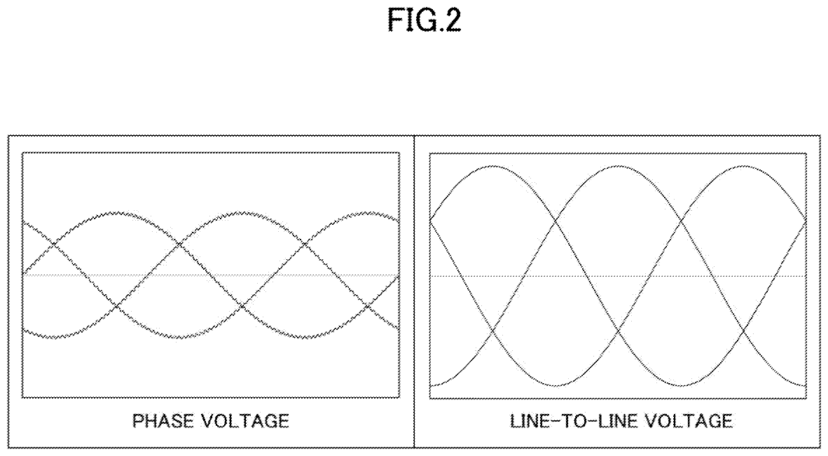

In the case of the occurrence of a DC ground fault that connects the power storage unit 43 to the ground at a ground fault point 44, however, the phase voltages Vu, Vv, and Vw and the line-to-line voltages Vuv, Vvw, and Vwu will have voltage waveforms as illustrated in FIG. 2. As can be seen, the phase voltages Vu, Vv, and Vw have fluctuations responsive to the frequency components inclusive of the carrier frequency Fc, but the line-to-line voltages Vuv, Vvw, and Vwu do not have fluctuations responsive to the frequency components inclusive of the carrier frequency Fc.

Examples of the DC ground fault of the power storage unit 43 include a ground fault caused by a leakage of the power storage unit 43, a ground fault of a wire connected to the power storage unit 43, and the like.

When a DC ground fault causes the power storage unit 43 to be connected to the ground at the ground fault point 44, abnormal current flows through the path from the AC power supply 10 to the grounding capacitors 21 to the grounding point 25 to the ground to the ground fault point 44 to the intermediate lines 40 to the converter 30 to the input lines 20 to the AC power supply 10, or flows through the path in the opposite direction. Since such abnormal AC current flows through the grounding capacitors 21, fluctuations responsive to the frequency components inclusive of the carrier frequency Fc are superimposed on the phase voltages Vu, Vv, and Vw. Even when the DC ground fault causes the power storage unit 43 to be connected to the ground at the ground fault point 44, the control unit 100 controls the converter 30 such that the line-to-line voltages Vuv, Vvw, and Vwu become equal to each other. As a result, fluctuations responsive to the frequency components inclusive of the carrier frequency Fc do not appear in the line-to-line voltages Vuv, Vvw, and Vwu.

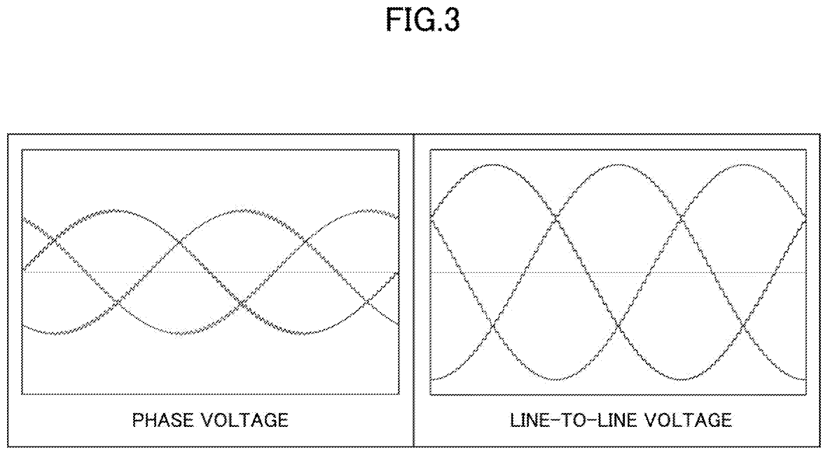

On the other hand, in the case of the occurrence of a short circuit failure or open circuit failure at the filter capacitors 23, the phase voltages Vu, Vv, and Vw and the line-to-line voltages Vuv, Vvw, and Vwu will have voltage waveforms as illustrated in FIG. 3. As can be seen, both the phase voltages Vu, Vv, and Vw and the line-to-line voltages Vuv, Vvw, and Vwu have fluctuations responsive to the frequency components inclusive of the carrier frequency Fc.

When the filter capacitors 23 suffer a short circuit failure or an open circuit failure, fluctuations responsive to the frequency components inclusive of the carrier frequency Fc cannot be suppressed by the filter capacitors 23. As a result, both the phase voltages Vu, Vv, and Vw and the line-to-line voltages Vuv, Vvw, and Vwu have fluctuations responsive to the frequency components inclusive of the carrier frequency Fc.

As described above, when a failure that causes an abnormal voltage to the input lines 20 occurs, abnormal fluctuations appear in the phase voltages Vu, Vv, and Vw as illustrated in FIGS. 2 and 3. In consideration of this, the control unit 100 may monitor the variation of each phase voltage detected by the phase voltage detecting unit 80, thereby detecting a failure that causes an abnormal voltage to the input lines 20. For example, the control unit 100 may check whether each phase voltage detected by the phase voltage detecting unit 80 includes fluctuations having a frequency corresponding to the carrier frequency of the converter 30, thereby detecting a failure that causes an abnormal voltage to the input lines 20. When the phase voltages detected by the phase voltage detecting unit 80 include fluctuations having a frequency corresponding to the carrier frequency of the converter 30, the control unit 100 determines that such a failure has occurred (see FIGS. 2 and 3). When a phase voltage detected by the phase voltage detecting unit 80 does not include fluctuations having a frequency corresponding to the carrier frequency of the converter 30, the control unit 100 may determine that no such a failure has occurred.

Further, the control unit 100 may monitor the variation of each phase voltage detected by the phase voltage detecting unit 80 and the variation of each line-to-line voltage detected by the line-to-line voltage detecting unit 90, thereby detecting a failure that causes an abnormal voltage to the input lines 20. For example, the control unit 100 monitors whether each phase voltage detected by the phase voltage detecting unit 80 includes fluctuations having a frequency corresponding to the carrier frequency of the converter 30 and whether each line-to-line voltage detected by the line-to-line voltage detecting unit 90 includes fluctuations having a frequency corresponding to the carrier frequency of the converter 30. Based on the monitoring results, the control unit 100 detects a failure that causes an abnormal voltage to the input lines 20.

For example, the control unit 100 may determine that the phase voltages detected by the phase voltage detecting unit 80 include fluctuations having a frequency corresponding to the carrier frequency of the converter 30 and that none of the line-to-line voltages detected by the line-to-line voltage detecting unit 90 include fluctuations having a frequency corresponding to the carrier frequency of the converter 30 (see FIG. 2). In this case, the control unit 100 determines that a failure that causes an abnormal voltage to the input lines 20 is a ground fault of the power storage unit 43. As another example, the control unit 100 may determine that the phase voltages detected by the phase voltage detecting unit 80 include fluctuations having a frequency corresponding to the carrier frequency of the converter 30 and that line-to-line voltages detected by the line-to-line voltage detecting unit 90 include fluctuations having a frequency corresponding to the carrier frequency of the converter 30 (see FIG. 3). In this case, the control unit 100 determines that a failure that causes an abnormal voltage to the input lines 20 is a failure of the filter capacitors 23.

Upon determining that a failure that causes an abnormal voltage to the input lines 20 is a ground fault of the power storage unit 43, the control unit 100 uses the intermediate contactor 42 to break the connection between the power storage unit 43 and the intermediate lines 40. This prevents abnormal AC current from flowing between the intermediate lines 40 and the ground fault point 44.

Upon determining that a failure that causes an abnormal voltage to the input lines 20 is a ground fault of the power storage unit 43, the control unit 100 uses the input contactors 24 to cut the AC power supplied to the converter 30. This prevents the AC power of the AC power supply 10 from being supplied to the intermediate lines 40 via the converter 30. In this case, in addition to cutting the AC power supplied to the converter 30, the control unit 100 may place the bypass contactors 71 in the conductive state, thereby causing the AC power of the AC power supply 10 to be output to the output lines 60 via the bypass circuit 70. This allows the AC power output of the AC power supply 10 to be supplied to the load 62 via the bypass circuit 70 even when the power storage unit 43 suffers a ground fault.

Upon determining that a failure that causes an abnormal voltage to the input lines 20 is a failure of the filter capacitors 23, the control unit 100 causes power to be output to the output lines 60 through a path that bypasses the filter capacitors 23. This allows the AC power output of the AC power supply 10 to be supplied to the load 62 via the path that bypasses the filter capacitors 23 even when the filter capacitors 23 suffer such a failure. Upon determining that a failure that causes an abnormal voltage to the input lines 20 is a failure of the filter capacitors 23, the control unit 100 may use the input contactors 24 to cut the AC power supplied to the converter 30, and causes the power of the power storage unit 43 to be output to the output lines 60 via the inverter 50. This allows the power stored in the power storage unit 43 to be supplied to the load 62 via the inverter 50 even when the filter capacitors 23 suffer a failure. Alternatively, upon determining that a failure that causes an abnormal voltage to the input lines 20 is a failure of the filter capacitors 23, the control unit 100 may cut the AC power supplied to the converter 30, and causes the AC power of the AC power supply 10 to be output to the output lines 60 via the bypass circuit 70. For example, the control unit 100 places the input contactors 24 in a nonconductive state, and places the bypass contactors 71 in a conductive state. With this arrangement, the AC power output of the AC power supply 10 is supplied to the load 62 via the bypass circuit 70 which bypasses the filter capacitors 23 even when the filter capacitors 23 suffer a failure.

The control unit 100 may monitor whether at least one of the phase voltages between the input lines 20 and the ground includes fluctuations having a frequency corresponding to the carrier frequency of the converter 30 during one or more predetermined cycles of the AC power supplied to the input lines 20. This arrangement reduces the likelihood that an erroneous monitoring regarding the occurrence of fluctuations is performed by monitoring the phase voltages during a period outside the one or more predetermined cycles.

The control unit 100 may monitor whether at least one of the line-to-line voltages between the phases includes fluctuations having a frequency corresponding to the carrier frequency of the converter 30 during one or more predetermined cycles of the AC power supplied to the input lines 20. This arrangement reduces the likelihood that an erroneous monitoring regarding the occurrence of fluctuations is performed by monitoring the line-to-line voltages during a period outside the one or more predetermined cycles.

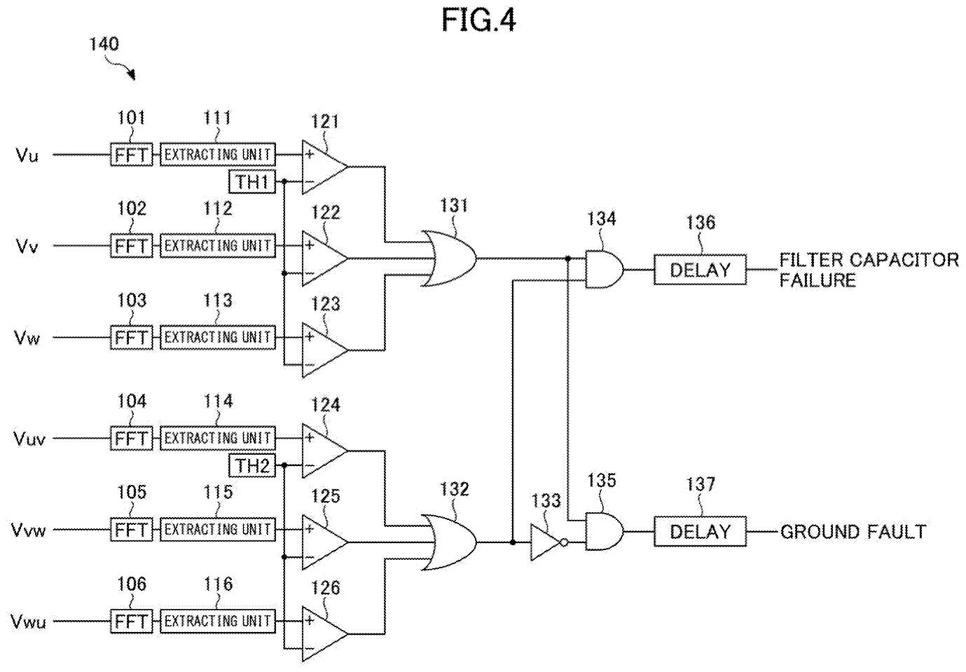

FIG. 4 is a block diagram illustrating an example of the configuration of a failure detecting unit in the control unit 100. A failure detecting unit 140 illustrated in FIG. 4 determines that the power storage unit 43 suffers a DC ground fault when at least one of the detected phase voltages includes fluctuations having a frequency corresponding to the carrier frequency of the converter 30 and none of the detected line-to-line voltages includes fluctuations having a frequency corresponding to the carrier frequency of the converter 30. The failure detecting unit 140 determines that the filter capacitors 23 suffer a failure when at least one of the detected phase voltages includes fluctuations having a frequency corresponding to the carrier frequency of the converter 30 and at least one of the detected line-to-line voltages includes fluctuations having a frequency corresponding to the carrier frequency of the converter 30.

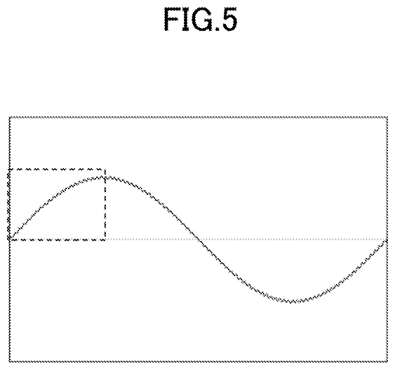

The failure detecting unit 140 includes FFT units 101, 102, and 103 for performing a fast Fourier transform on the respective phase voltages detected by the phase voltage detecting unit 80, and includes FFT units 104, 105, and 106 for performing a fast Fourier transform on the respective line-to-line voltages detected by the line-to-line voltage detecting unit 90. FFT is an abbreviation of the fast Fourier transform. The FFT units 101 through 106 detect the frequency components of the respective voltages by performing an FFT on a quarter cycle of the voltage waveform (see FIG. 5).

The failure detecting unit 140 includes an extracting unit 111 for extracting a frequency component including the carrier frequency Fc from the frequency components of the phase voltage Vu detected by the FFT unit 101, and includes a comparing unit 121 for comparing the frequency component extracted by the extracting unit 111 with a threshold value TH1. The failure detecting unit 140 uses the result of a comparison performed by the comparing unit 121 to monitor whether the phase voltage Vu detected by the phase voltage detecting unit 80 includes fluctuations having a frequency corresponding to the carrier frequency of the converter 30.

Similarly, the failure detecting unit 140 uses an extracting unit 112 and a comparing unit 122 to monitor whether the phase voltage Vv detected by the phase voltage detecting unit 80 includes fluctuations having a frequency corresponding to the carrier frequency of the converter 30. Similarly, the failure detecting unit 140 uses an extracting unit 113 and a comparing unit 123 to monitor whether the phase voltage Vw detected by the phase voltage detecting unit 80 includes fluctuations having a frequency corresponding to the carrier frequency of the converter 30. The failure detecting unit 140 includes a logic sum gate 131 for determining whether at least one of the detected phase voltages Vu, Vv, and Vw includes fluctuations having a frequency corresponding to the carrier frequency of the converter 30.

The failure detecting unit 140 includes an extracting unit 114 for extracting a frequency component including the carrier frequency Fc from the frequency components of the line-to-line voltage Vuv detected by the FFT unit 104, and includes a comparing unit 124 for comparing the frequency component extracted by the extracting unit 114 with a threshold value TH2. The failure detecting unit 140 uses the result of a comparison performed by the comparing unit 124 to monitor whether the line-to-line voltage Vuv detected by the line-to-line voltage detecting unit includes fluctuations having a frequency corresponding to the carrier frequency of the converter 30.

Similarly, the failure detecting unit 140 uses an extracting unit 115 and a comparing unit 125 to monitor whether the line-to-line voltage Vvw detected by the line-to-line voltage detecting unit includes fluctuations having a frequency corresponding to the carrier frequency of the converter 30. Similarly, the failure detecting unit 140 uses an extracting unit 116 and a comparing unit 126 to monitor whether the line-to-line voltage Vwu detected by the line-to-line voltage detecting unit includes fluctuations having a frequency corresponding to the carrier frequency of the converter 30. The failure detecting unit 140 includes a logic sum gate 132 for determining whether at least one of the detected line-to-line voltages Vuv, Vvw, and Vwu includes fluctuations having a frequency corresponding to the carrier frequency of the converter 30.

Logic product gates 134 and 135 each have two inputs, one of which receives the output of the logic sum gate 131. The output of the logic sum gate 132 is input into the other input of the logic product gate 134, and is supplied through a negative gate 133 to the other input of the logic product gate 135.

The failure detecting unit 140 outputs a high-level detection signal from the logic product gate 135 when at least one of the detected phase voltages includes fluctuations having a frequency corresponding to the carrier frequency of the converter 30 and none of the detected line-to-line voltages includes fluctuations having a frequency corresponding to the carrier frequency of the converter 30. The high-level detection signal output from the logic product gate 135 indicates that a DC ground fault of the power storage unit 43 is deemed to have occurred. In order to avoid an erroneous detection of a DC ground fault of the power storage unit 43, the failure detecting unit 140 may include a delay circuit 137 for finalizing the detection result of a DC ground fault of the power storage unit 43 after the passage of a predetermined delay time during which the output signal of the logic product gate 135 continues to be at a high level.

The failure detecting unit 140 outputs a high-level detection signal from the logic product gate 134 when at least one of the detected phase voltages includes fluctuations having a frequency corresponding to the carrier frequency of the converter 30 and at least one of the detected line-to-line voltages includes fluctuations having a frequency corresponding to the carrier frequency of the converter 30. The high-level detection signal output from the logic product gate 134 indicates that a failure of the filter capacitors 23 is deemed to have occurred. In order to avoid an erroneous detection of a failure of the filter capacitors 23, the failure detecting unit 140 may include a delay circuit 136 for finalizing the detection result of a failure of the filter capacitors 23 after the passage of a predetermined delay time during which the output signal of the logic product gate 134 continues to be at a high level.

Each function of the control unit 100 is implemented by a processor such as a CPU executing a program that is stored in a memory in a retrievable manner.

Although the uninterrupted power supply apparatus has been described with reference to the embodiments, the present invention is not limited to these embodiments. Various variations and modifications such as combining or replacing part or all of an embodiment with another embodiment may be made without departing from the scope of the present invention.

For example, the number of AC power phases is not limited to three.

What is claimed is:

1. An uninterrupted power supply apparatus, comprising:
input lines configured to receive AC power from an AC power supply having a grounded neutral point;
a converter configured to convert the AC power of the input lines into DC power for output to intermediate lines;
a power storage unit connected to the intermediate lines;
an inverter configured to convert DC power of the intermediate lines into AC power for output to output lines;
grounding capacitors connected between the input lines and a ground;
a phase voltage detecting unit configured to detect phase voltages between the input lines and the ground; and
a control unit configured to monitor fluctuations of the phase voltages detected by the phase voltage detecting unit to detect a failure that causes abnormal voltage to the input lines.

2. The uninterrupted power supply apparatus as claimed in claim 1, wherein the control unit is configured to monitor whether the phase voltages detected by the phase voltage detecting unit include fluctuations having a frequency corresponding to a carrier frequency of the converter, thereby detecting the failure.

3. The uninterrupted power supply apparatus as claimed in claim 2, wherein the control unit is configured to determine that the failure has occurred, upon detecting that the phase voltages detected by the phase voltage detecting unit include fluctuations having a frequency corresponding to the carrier frequency of the converter.

4. The uninterrupted power supply apparatus as claimed in claim 2, wherein the control unit is configured to extract a frequency component including the carrier frequency from frequency components detected by performing a fast Fourier transform on the phase voltages detected by the phase voltage detecting unit, and to compare the extracted frequency component with a threshold, thereby monitoring whether the phase voltages detected by the phase voltage detecting unit include fluctuations having a frequency corresponding to the carrier frequency of the converter.

5. The uninterrupted power supply apparatus claimed in claim 3, wherein the control unit is configured to extract a frequency component including the carrier frequency from frequency components detected by performing a fast Fourier transform on the phase voltages detected by the phase voltage detecting unit, and to compare the extracted frequency component with a threshold, thereby monitoring whether the phase voltages detected by the phase voltage detecting unit include fluctuations having a frequency corresponding to the carrier frequency of the converter.

6. The uninterrupted power supply apparatus as claimed in claim 1, further comprising a line-to-line voltage detecting unit configured to detect line-to-line voltages between the input lines,
wherein the control unit is configured to monitor fluctuations in the phase voltages detected by the phase voltage detecting unit and fluctuations in the line-to-line voltages detected by the line-to-line voltage detecting unit, thereby detecting the failure.

7. The uninterrupted power supply apparatus as claimed in claim 6, wherein the control unit is configured to monitor whether the phase voltages detected by the phase voltage detecting unit include fluctuations having a frequency corresponding to the carrier frequency of the converter and whether the line-to-line voltages detected by the line-to-line voltage detecting unit include fluctuations having a frequency corresponding to a carrier frequency of the converter, thereby detecting the failure.

8. The uninterrupted power supply apparatus as claimed in claim 7, wherein the control unit is configured to extract a frequency component including the carrier frequency from frequency components detected by performing a fast Fourier transform on the line-to-line voltages detected by the line-to-line voltage detecting unit, and to compare the extracted frequency component with a threshold, thereby monitoring whether the line-to-line voltages detected by the line-to-line voltage detecting unit include fluctuations having a frequency corresponding to the carrier frequency of the converter.

9. The uninterrupted power supply apparatus as claimed in claim 7, wherein the control unit is configured to determine that the failure is a ground fault of the power storage unit, in response to detecting that the phase voltages detected by the phase voltage detecting unit include fluctuations having a frequency corresponding to the carrier frequency of the converter and that none of the line-to-line voltages detected by the line-to-line voltage detecting unit include fluctuations having a frequency corresponding to the carrier frequency of the converter.

10. The uninterrupted power supply apparatus as claimed in claim 8, wherein the control unit is configured to determine that the failure is a ground fault of the power storage unit, in response to detecting that the phase voltages detected by the phase voltage detecting unit include fluctuations having a frequency corresponding to the carrier frequency of the converter and that none of the line-to-line voltages detected by the line-to-line voltage detecting unit include fluctuations having a frequency corresponding to the carrier frequency of the converter.

11. The uninterrupted power supply apparatus as claimed in claim 9, wherein the control unit is configured to break a connection between the power storage unit and the intermediate lines in response to determining that the failure is a ground fault of the power storage unit.

12. The uninterrupted power supply apparatus as claimed in claim 9, wherein the control unit is configured to cut AC power supplied to the converter in response to determining that the failure is a ground fault of the power storage unit.

13. The uninterrupted power supply apparatus as claimed in claim 12, wherein the control unit is configured to cause the AC power from the AC power supply to be output to the output lines through a bypass circuit that bypasses the converter, the intermediate lines, and the inverter, in response to determining that the failure is a ground fault of the power storage unit.

14. The uninterrupted power supply apparatus as claimed in claim 7, further comprising filter capacitors connected to the input lines in a star connection,
wherein the control unit is configured to determine that the failure is a failure of the filter capacitors, in response to detecting that the phase voltages detected by the phase voltage detecting unit include fluctuations having a frequency corresponding to the carrier frequency of the converter and that the line-to-line voltages detected by the line-to-line voltage detecting unit include fluctuations having a frequency corresponding to the carrier frequency of the converter.

15. The uninterrupted power supply apparatus as claimed in claim 9, further comprising filter capacitors connected to the input lines in a star connection,
wherein the control unit is configured to determine that the failure is a failure of the filter capacitors, in response to detecting that the phase voltages detected by the phase voltage detecting unit include fluctuations having a frequency corresponding to the carrier frequency of the converter and that the line-to-line voltages detected by the line-to-line voltage detecting unit include fluctuations having a frequency corresponding to the carrier frequency of the converter.

16. The uninterrupted power supply apparatus as claimed in claim 14, wherein the control unit is configured to cause power to be output to the output lines through a path that bypasses the filter capacitors, in response to determining that the failure is a failure of the filter capacitors.

17. The uninterrupted power supply apparatus as claimed in claim 16, wherein the control unit is configured to cut AC power supplied to the converter and to cause power of the power storage unit to be output to the output lines through the inverter, in response to determining that the failure is a failure of the filter capacitors.

18. The uninterrupted power supply apparatus as claimed in claim 16, wherein the control unit is configured to cut AC power supplied to the converter and to cause the AC power from the AC power supply to be output to the output lines through a bypass circuit that bypasses the filter capacitors, the converter, the intermediate lines, and the inverter, in response to determining that the failure is a failure of the filter capacitors.

19. The uninterrupted power supply apparatus as claimed in claim 1, wherein the AC power supply is a three-phase AC power supply, and the control unit is configured to monitor whether at least one of the phase voltages between the input lines and the ground includes fluctuations having a frequency corresponding to a carrier frequency of the converter during one or more cycles of the AC power from the AC power supply.
